(19) United States
(12) Patent Application Publication
(10) Pub. No.: US 2015/0213926 A1
(43) Pub. Date: Jul. 30, 2015

(54) VOLTAGE NONLINEAR RESISTIVE ELEMENT

(71) Applicant: NGK Insulators, Ltd., Nagoya-City (JP)

(72) Inventor: Naokuni MURAMATSU, Nagoya-City (JP)

(21) Appl. No.: 14/678,026

(22) Filed: Apr. 3, 2015

Related U.S. Application Data
(63) Continuation of application No. PCT/JP2013/076950, filed on Oct. 3, 2013.

(30) Foreign Application Priority Data
Oct. 10, 2012 (JP) 2012-225160

(51) Int. Cl. H01C 7/12

(52) U.S. Cl. CPC H01C 7/12

(57) ABSTRACT

A voltage nonlinear resistive element of the present invention includes a voltage nonlinear resistive material composed of a copper alloy containing a Cu—Zr compound phase, and electrodes. In the voltage nonlinear resistive material, the Cu—Zr compound phase preferably contains at least one of a Cu₉Zr₂ phase, a Cu₅Zr phase, and a Cu₈Zr₃ phase. The voltage nonlinear resistive material preferably contains a composite phase that contains a Cu phase and the Cu—Zr compound phase. More preferably, the composite phase is a eutectic phase containing the Cu phase and the Cu₉Zr₂ phase.

### BACKGROUND OF THE INVENTION

1. Field of the Invention

The present invention relates to a voltage nonlinear resistive element.

2. Description of the Related Art

Hitherto, varistors and parallel circuits of Zener diodes and capacitors have been known as components configured to protect circuits and elements of electronic devices from overvoltage, such as abnormal voltage (surge) and static electricity (electrostatic discharge (ESD)). Varistors are more frequently used than parallel circuits of Zener diodes and capacitors because varistors can be miniaturized. Typical examples of varistors include ZnO varistors. Such a ZnO varistor generally has a crystalline structure produced by a firing process of a ceramic powder. It is believed that a high-resistance grain-boundary region and a low-resistance grain region are present, a Schottky barrier is formed at the interface between both the regions, and a current is rapidly increased (voltage nonlinear resistive characteristics are exhibited) by a mechanism mainly including a tunnel effect due to overvoltage.

Recent trends toward the miniaturization and higher integration of electronic devices have further required smaller and lower-voltage varistors. To meet such a requirement, for example, it is reported that a grain size is controlled by devising an additional element and a firing process and fired thin ceramic layers and that electrode layers are alternately stacked (see Patent Literatures 1 to 3).

### CITATION LIST

### Patent Literature

PTL 1: Japanese Unexamined Patent Application Publication No. 5-055010

PTL 2: Japanese Unexamined Patent Application Publication No. 5-234716

PTL 3: Japanese Unexamined Patent Application Publication No. 5-226116

### SUMMARY OF INVENTION

### Technical Problem

However, ZnO varistors typically have a varistor voltage of tens of volts. The varistors described in Patent Documents 1 to 3 also have a varistor voltage of 3 V or more. Thus, it is desirable to further reduce the voltage. In addition, the miniaturization is not sufficient.

The present invention has accomplished to overcome the foregoing problems. It is a main object of the present invention to provide a novel voltage nonlinear resistive element.

### Solution to Problem

The inventors have conducted intensive studies and have found the following: A copper alloy including copper matrix phases and eutectic phases containing Cu and Cu₉Zr₂ is produced. Studies on the current-voltage characteristics thereof indicate that the copper alloy has voltage nonlinear resistive characteristics and that a current is rapidly increased at a relatively low voltage of about 1 to 3 V. The findings have led to the completion of the present invention.

A voltage nonlinear resistive element of the present invention includes: a voltage nonlinear resistive material containing a Cu—Zr compound phase; and electrodes.

### Advantageous Effects of Invention

In the present invention, it is possible to produce a voltage nonlinear resistive element with a material that has not been known as a voltage nonlinear resistive material in the past. The reason such effects are provided is unclear but is speculated as follows: The voltage nonlinear resistive material of the present invention is believed to include a region composed of copper and a region containing at least zirconium. The former plays the same role as a low-resistance grain region of a ZnO varistor. The latter plays the same role as a high-resistance grain-boundary region of a ZnO varistor. An electrical barrier just like a Schottky barrier is formed at the interface between both the regions. Thereby, a current is rapidly increased by a mechanism similar to a tunnel effect due to overvoltage.

### BRIEF DESCRIPTION OF THE DRAWINGS

FIG. 1 is a Cu—Zr binary phase diagram.

FIG. 2 is a schematic view of an example of the structure 60 of an ingot.

FIG. 3 is a schematic view of an example of a voltage nonlinear resistive element of the present invention.

FIG. 4 is a SEM photograph of a 5-mm-diameter ingot containing 4.0 at % Zr.

FIG. 5 illustrates SEM photographs of sample No. 1-6 of a copper alloy wire rod.

FIG. 6 illustrates SEM photographs of sample No. 1-6 of a copper alloy wire rode.

FIG. 7 is an STEM photograph of a portion that appears white in FIG. 6.

FIG. 8 schematically illustrates an amorphous phase in a eutectic phase.

FIG. 9 illustrates SEM photographs of sample No. 3-12 of a copper alloy wire rod.

FIG. 10 illustrates STEM photographs of sample No. 3-12.

FIG. 11 illustrates EDX analysis results at points (1 to 3) in FIG. 10.

FIG. 12 illustrates NBD analysis results at Point 2 in FIG. 10.

FIG. 13 is a SEM composition image of a wire rod of Example 1.

FIG. 14 illustrates a planar image and a current image in field of view 1 in FIG. 13.

FIG. 15 illustrates a current image and I-V curves in field of view 2 in FIG. 13.

FIG. 16 illustrates a current image and I-V curves in field of view 3 in FIG. 13.

FIG. 17 is a SEM composition image of a wire rod of Example 2.

FIG. 18 illustrates a current image and I-V curves in field of view 1 in FIG. 17.

FIG. 19 illustrates current images and I-V curves in field of view 2 in FIG. 17.

FIG. 20 illustrates a current image and I-V curves in field of view 3 in FIG. 17.

### DETAILED DESCRIPTION OF THE INVENTION

A voltage nonlinear resistive element of the present invention includes a voltage nonlinear resistive material composed of a copper alloy containing a Cu—Zr compound phase and electrodes. The voltage nonlinear resistive material used here indicates a material having nonlinear current-voltage resistance characteristics. Examples thereof include materials having current-voltage characteristics, such as the current-voltage characteristics of diodes; and materials having current-voltage characteristics, such as the current-voltage characteristics of varistors.

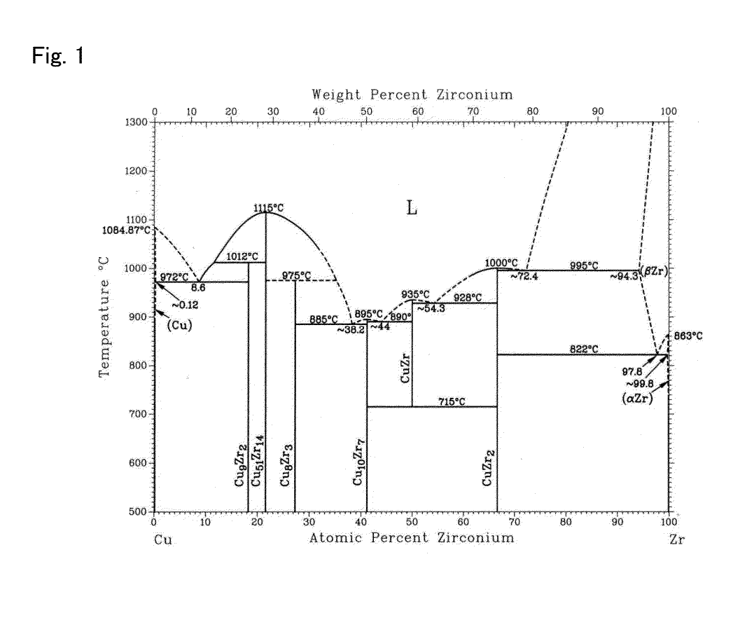

In the voltage nonlinear resistive element of the present invention, a voltage nonlinear resistive material is a copper alloy containing a Cu—Zr compound phase. FIG. 1 illustrates a Cu—Zr binary phase diagram with the Zr content on the horizontal axis and temperature on the vertical axis (cited from D. Arias and J. P. Abriata, Bull. Alloy Phase Diagram 11 (1990) 452-459). Examples of the Cu—Zr compound phase include various Cu—Zr compound phases described in the Cu—Zr binary phase diagram illustrated in FIG. 1. Of these, the Cu₉Zr₂ phase, the Cu₈Zr₃ phase, and so forth are preferred. The reason for this is presumably as follows: A Cu₉Zr₂ phase, a Cu₈Zr₃ phase, and so forth have relatively low Zr contents. Thus, a high-resistance Zr-containing region is not excessively increased. Something like a Schottky barrier is appropriately formed. The phases may be identified by, for example, making structure observation with a scanning transmission electron microscope (STEM) and then performing a composition analysis with an energy-dispersive X-ray (EDX) spectroscope and performing a structural analysis by nano-beam diffraction (NBD) in the field of view where the structure observation is performed. A Cu₅Zr phase, which is a compound having a composition very close to that of the Cu₉Zr₂ phase and is not described in the Cu—Zr binary phase diagram, is also known. Like the Cu₉Zr₂ phase, the Cu₅Zr phase is also preferred. The voltage nonlinear resistive material may include a single type of Cu—Zr compound phase or two or more types of Cu—Zr compound phases. For example, the voltage nonlinear resistive material may include the single Cu₉Zr₂ phase, the single Cu₅Zr phase, the single Cu₈Zr₃ phase, a phase including the Cu₉Zr₂ phase as a main phase and at least one of the Cu₅Zr phase and the Cu₈Zr₃ phase as a sub-phase, a phase including the Cu₅Zr phase as a main phase and at least one of the Cu₉Zr₂ phase and the Cu₈Zr₃ phase as a sub-phase, and a phase including the Cu₈Zr₃ phase as a main phase and at least one of the Cu₉Zr₂ phase and the Cu₅Zr phase. Here, the main phase indicates a phase with the highest proportion (on a volume basis) among the Cu—Zr compound phases. The sub-phase indicates a phase other than the main phase among the Cu—Zr compound phases.

The voltage nonlinear resistive material may include a Cu phase and the foregoing Cu—Zr compound phase, the Cu phase and the Cu—Zr compound phase constituting a composite phase. In such a material, it is believed that the Cu phase serves as a low-resistance region, the Cu—Zr compound phase serves as a high-resistance region, and something like a Schottky barrier is formed at the interface between both regions. Examples of the composite phase that is believed to be preferred include a composite phase of the Cu phase and the Cu₉Zr₂ phase, a composite phase of the Cu phase and the Cu₅Zr phase, and a composite phase of the Cu phase and the Cu₈Zr₃ phase. The composite phase of the Cu phase and the Cu₉Zr₂ phase is often a eutectic phase including, for example, the Cu phase and the Cu₉Zr₂ phase. The composite phase may include a plurality of Cu—Zr compound phases having different compositions. The voltage nonlinear resistive material may include a plurality of types of composite phases. The composite phase may constitute a fibrous structure or lamellar structure in which the Cu phases and the Cu—Zr compound phases are alternately arranged in parallel. The fibrous structure and the lamellar structure each indicate a structure in which when a cross section parallel to the direction in which fibers or layers extend is observed, regions (grains) that can be identified as different phases are alternately arranged in parallel (hereinafter, the same shall apply). Preferably, the thicknesses of the Cu phases and the Cu—Zr compound phases are each, but not particularly limited to, 50 nm or less, more preferably 40 nm or less, and still more preferably 30 nm or less. The reason for this is presumably that the Cu—Zr compound phases serving as high-resistance regions have a small thickness, so that a current flows at a lower voltage. The thicknesses of the Cu phases and the Cu—Zr compound phases are each preferably more than 7 nm, more preferably 10 nm or more, and still more preferably 20 nm or more from the viewpoint of easy production. Here, the thicknesses of the Cu phases and the Cu—Zr compound phases may be determined as described below. A wire rod or foil thinned by an Ar ion milling method is prepared as a sample for STEM observation. A portion of a central section where a composite phase is seen is observed at a magnification of ×500,000. High-angle annular dark-field images with a scanning electron microscope (STEM-HAADF images) are captured in three fields of view each having a size of 300 nm×300 nm. The measurable thicknesses of all the Cu phases and the Cu—Zr compound phases in the STEM-HAADF images are measured. The total of resulting thickness values is divided by the total of the number of the Cu phases and the number of the Cu—Zr compound phases whose thicknesses have been measured, thereby determining the average value. The resulting average value is used as the thickness of each of the Cu phases and the Cu—Zr compound phases. Each of the Cu phases may have a thickness substantially equal to that of each of the Cu—Zr compound phases. Each Cu phase portion may have a larger thickness than that of each Cu—Zr compound phase portion. The Cu—Zr compound phase portion may have a larger thickness than that of the Cu phase portion. The composite phase may include an amorphous phase. The amount of the amorphous phase is not particularly limited. The composite phase preferably contains the amorphous phase in an area proportion of 5% or more and 25% or less, more preferably 10% or more, and still more preferably 15% or more when a cross section parallel to the direction in which the fibers or layers extend is viewed. The reason for this is presumably that in the case of the composite phase containing the amorphous phase in an area proportion of 5% or more, a current flows at a lower voltage because of a small thickness of the Cu—Zr compound phases serving as high-resistance regions and that the composite phase containing the amorphous phase in an area proportion of 25% or less is relatively easily produced. The amorphous phases are mainly formed at the interfaces between the Cu phases and the Cu—Zr compound phases. Here, the area proportion of the amorphous phases may be determined as described below. A wire rod or foil thinned by an Ar ion milling method is prepared as a sample for STEM observation. A portion of a central section where a composite phase is seen is observed at a magnification of ×500,000. Lattice images are captured in three fields of view each having a size of 300 nm×300 nm. The area proportions of possible amorphous regions where atoms randomly arranged are measured on the lattice images captured with the STEM. The average value of the area proportions is determined and used as the area proportion of the amorphous phase (hereinafter, also referred to as an “amorphous proportion”).

The voltage nonlinear resistive material may include copper matrix phases in addition to the foregoing composite phases. The reason for this is presumably that in this case, the copper matrix phases serve as a low-resistance region, the composite phases serve as high-resistance regions, and something like a Schottky barrier is formed at the interface between both the regions. Here, the voltage nonlinear resistive material may have a structure in which the copper matrix phases and the composite phases constitute a fibrous structure or lamellar structure and in which the Cu phases and the Cu—Zr compound phases in each of the composite phases constitute a fibrous structure or lamellar structure parallel thereto. In this case, the area proportion of the composite phases is preferably 40% or more and 60% or less, more preferably 45% or more and 60% or less, and still more preferably 50% or more and 60% or less when a cross section perpendicular to the direction in which fibers or layers extend is observed. The reason for this is presumably that at an area proportion of 40% or more, a current flows at a lower voltage because the Cu—Zr compound phases serving as high-resistance regions each have a small thickness in the composite phases. An area proportion of 60% or less results in the inhibition of breakage that can be initiated from the hard Cu—Zr compound phase at the time of processing because the composite phase is not excessively increased. The thicknesses of the copper matrix phases and the composite phases are each preferably, but not particularly limited to, 200 μm or less, more preferably 50 μm or less, and still more preferably 10 μm or less. The reason for this is presumably that at 200 μm or less, a current flows at a lower voltage because the composite phases serving as high-resistance regions and the Cu—Zr compound phases in the composite phases have small thicknesses. In the case where the copper matrix phases and the composite phases constitute a fibrous structure or lamellar structure, each Cu—Zr compound phase is often a Cu₉Zr₂ single phase or often contains a Cu₉Zr₂ phase as a main phase. The voltage nonlinear resistive material may be a material in which short fiber-shaped composite phases are dispersed in the copper matrix phases. The term “short fiber-shaped” used here may indicate a shape in which, for example, when a cross section parallel to the direction in which short fibers extend is observed, in the case that the length of each of the short fibers in the direction in which the short fibers extend is denoted by L and the length (thickness) of each of the short fibers in a direction perpendicular to the direction in which the short fibers extend is denoted by T, 1.5≦L/T<17.9 is satisfied. In the case where the short fiber-shaped composite phases are dispersed in the copper matrix phases, when a cross section perpendicular to the direction in which the short fibers extend is observed, the area proportion of the composite phases may be 0.5% or more and 5% or less. In the case where the short fiber-shaped composite phases are dispersed in the copper matrix phases, each of the Cu—Zr compound phases is often a Cu₈Zr₃ single phase or often contains Cu₈Zr₃ as a main phase. When the proportion of the composite phases and L/T are determined, they are preferably determined by observation with a SEM at a magnification of about ×1000. In a SEM photograph, the composite phases appear whitish, and the copper matrix phases appear blackish. When the contrast is not clear, binarization or the like may be performed for observation. When the binarization is performed, a threshold value commonly used by a person skilled in the art may be used.

The voltage nonlinear resistive material contains Cu and Zr. The Zr content is preferably, but not particularly limited to, 18 at % or less. The reason for this is that, as is clear from the binary phase diagram illustrated in FIG. 1, the Cu₉Zr₂ phase is obtained. The Zr content is preferably 0.2 at % or more and 8.0 at % or less and preferably 0.35 at % or more and 7.0 at % or less. The reason for this is that a Zr content of 0.2 at % or more results in voltage nonlinear resistive characteristics and that a Zr content of 8.0 at % or less results in satisfactory processability, thus facilitating the miniaturization of a structure by processing. The Zr content may also be 8.0 at % or more and 18.0 at % or less. In this case, the voltage nonlinear resistive material mainly contains the composite phase and the Cu—Zr compound phase and thus is believed to be suitably used for a high-breakdown-voltage voltage nonlinear resistive element. The voltage nonlinear resistive material may contain an element except Cu and Zr. Examples of such an element include intentionally added elements and impurities with which the material is inevitably contaminated in the course of a production process and so forth.

The voltage nonlinear resistive element may be produced by a production method including (1) a melting step of melting Cu and Zr to produce a molten metal, (2) a casting step of casting the molten metal to produce an ingot, and (3) a processing step of subjecting the ingot to wire drawing or rolling to produce a drawn wire rod or a rolled article. By such a production method, it is possible to easily produce the voltage nonlinear resistive material including the composite phase in which the Cu phases and the Cu—Zr compound phases constitute a fibrous structure or lamellar structure; the voltage nonlinear resistive material in which the copper matrix phases and the composite phases constitute a fibrous structure or lamellar structure and in which the Cu phases and the Cu—Zr compound phases in the composite phases constitute a fibrous structure or lamellar structure parallel thereto; and the voltage nonlinear resistive material in which the short fiber-shaped composite phases are dispersed in the copper matrix phases. Furthermore, the wire drawing or the rolling provides the effect of relatively easily controlling the structure. For example, the dimensions and the shape of grains included in the fibrous structure, the lamellar structure, the short fiber-shaped composite phases, and so forth can be relatively easily controlled. The characteristics (varistor voltage, surge current withstand, and clamping voltage) of the voltage nonlinear resistive element depend on the numbers of high-resistance regions arranged in series and parallel between the electrodes. Thus, a voltage at which a current starts flowing through the voltage nonlinear resistive element can be relatively easily controlled by changing the conditions of the wire drawing or rolling.

The steps will be described in sequence below.

### (1) Melting Step

In this step, a process for melting Cu and Zr to produce a molten metal is performed. The proportions of the raw materials may be appropriately set so as to produce a copper alloy having a desired composition. The Zr content is preferably 18 at % or less, preferably 0.2 at % or more and 8.0 at % or less, and more preferably 0.35 at % or more and 7.0 at % or less. A Zr content of 0.2 at % or more results in voltage nonlinear resistive characteristics. A Zr content of 8.0 at % or less results in satisfactory processability, thus facilitating the miniaturization of a structure by processing. For example, at a Zr content of 3 at % or more, it is possible to easily produce the voltage nonlinear resistive material in which the copper matrix phases and the composite phases constitute a fibrous structure or lamellar structure and in which the Cu phases and the Cu—Zr compound phases in the composite phases constitute a fibrous structure or lamellar structure parallel thereto. At a Zr content less than 3 at %, it is possible to easily produce the voltage nonlinear resistive material in which the short fiber-shaped composite phases are dispersed in the copper matrix phases. As the raw materials, an alloy or a pure metal may be used. Examples of a melting method that may be employed include, but are not particularly limited to, a common high-frequency induction melting method, a low-frequency induction melting method, an arc melting method, an electron beam melting method, and a levitation melting method. Of these, the high-frequency induction melting method or the levitation melting method is preferably employed. In the high-frequency induction melting method, a large amount of the raw materials can be melted in one step. In the levitation melting method, a metal to be melted is levitated and melted, thus further inhibiting the contamination of impurities from a crucible or the like. The melting atmosphere is preferably a vacuum atmosphere or an inert atmosphere. The inert atmosphere may be a gas atmosphere that has no influence on an alloy composition. For example, a nitrogen atmosphere, a helium atmosphere, an argon atmosphere, may be used. Of these, the argon atmosphere is preferably used.

(2) Casting Step

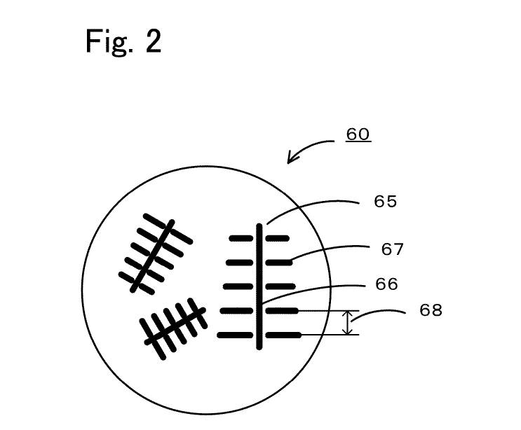

In this step, a process for producing an ingot by pouring the molten metal into a mold to perform casting is performed. Examples of a casting method that may be employed include, but are not particularly limited to, a metal mold casting method, a low-pressure casting method, die casting methods, such as a common die casting method, a squeeze casting method, and a vacuum die casting method, and a continuous casting method. The mold used for the casting may be composed of pure copper, a copper alloy, an alloy steel, or the like. Of these, the mold composed of pure copper is preferred because it provides a high cooling rate and thus is suitable to provide a finer structure. In the voltage nonlinear resistive material, it is believed that when the finer structure is obtained, no excessively large high-resistance region is formed, and a mechanism, such as a tunnel effect, acts appropriately. The structure of the mold is not particularly limited. A mold capable of adjusting a cooling rate by arranging a water cooling pipe inside the mold may be used. The shape of the resulting ingot is not particularly limited. The ingot preferably has a bar- or plate-like shape. The reason for this is that a uniform cast structure is obtained and that the cooling rate can be further increased, so that the shape is suitable for a reduction in the size of the structure. The pouring temperature is preferably 1100° C. or higher and 1300° C. or lower and more preferably 1150° C. or higher and 1250° C. or lower. The reason for this is as follows: A pouring temperature of 1100° C. or higher results in satisfactory metal flow. A pouring temperature of 1300° C. or lower is not likely to cause the mold to be degraded. FIG. 2 is a schematic view of an example of the structure 60 of the resulting ingot. The structure 60 is often obtained when a raw material containing 3 at % or more Zr is used. The ingot having the structure is subjected to the subsequent processing step to easily produce the voltage nonlinear resistive material in which the Cu phases and the Cu—Zr compound phases constitute a fibrous structure or lamellar structure, and the voltage nonlinear resistive material in which the copper matrix phases and the composite phases constitute a fibrous structure or lamellar structure and in which the Cu phases and the Cu—Zr compound phases in each of the composite phases constitute a fibrous structure or lamellar structure parallel thereto. The structure of the ingot illustrated in FIG. 2 has a dendritic structure including a plurality of dendrites. Dendrites 65 consist of proeutectic copper phases and each include a primary dendrite arm 66 serving as a trunk and a plurality of secondary dendrite arms 67 serving as branches extending from the primary dendrite arm 66. The secondary dendrite arms 67 extend in a direction substantially perpendicular to the primary dendrite arm 66. A secondary dendrite arm spacing 68 (secondary DAS) is preferably 10.0 μm or less, more preferably 9.4 μm or less, and still more preferably 4.1 μm or less. A secondary DAS of 10.0 μm or less results in a dense fibrous structure or lamella structure including the copper matrix phases and the composite phases in the subsequent processing step, thereby further increasing the tensile strength. The secondary DAS is preferably larger than 1.0 μm and more preferably 1.6 μm or more in view of ingot production. The secondary DAS may be determined as described below. Three dendrites 65 having a series of four or more secondary dendrite arms 67 are selected in a cross section of the ingot perpendicular to the axial direction of the ingot 60. Each spacing 68 between the series of four secondary dendrite arms 67 of each of the dendrites is measured. The average value of a total of nine spacings 68 is determined and used as the secondary DAS.

(3) Processing Step

In this step, a process for producing a copper alloy wire rod or a copper alloy sheet (foil) by subjecting the ingot to wire drawing or rolling is performed. In the processing step, cold processing is preferably performed. The term “cold” used here indicates that the processing is performed at a temperature near normal temperature (for example, at about 20° C. to about 30° C.) without heating. The cold processing enables recrystallization and recovery of the structure to be inhibited and thus is suitable for a reduction in the size of the structure, which is preferred.

A method of wire drawing is not particularly limited. Examples thereof include drawing, such as hole die drawing and roller die drawing, extrusion, swaging, and grooved roll working. The wire drawing is preferably performed in such a manner that shear slip deformation is caused in the ingot by the application of a shear force in a direction parallel to the axis of drawing (hereinafter, also referred to as “shearing wire drawing”). By the drawing that causes shear slip deformation, a uniform fibrous structure can be obtained, thereby resulting in stable characteristics of the voltage nonlinear resistive element. The drawing is particularly suitable for wire drawing with a high drawing ratio. It is thus possible to reduce the size of the structure by severe plastic deformation. As the drawing that causes shear slip deformation, specifically, for example, drawing in which an ingot is drawn through a die is suitable. In the drawing, simple shear deformation can be provided in an object to be subjected to wire drawing by friction at the contact surface between the object and the die. In the case where drawing is performed with a die, the drawing may be performed to a final wire diameter with a plurality of dies having different sizes. In this case, a wire is less likely to be broken during wire drawing. The hole of such a die does not have to be circular. A die for square wires, a die for wires of special shape, a die for tubes, and so forth may be used. In the case where wire drawing is performed, a step of subjecting an ingot to cold wire drawing to a reduction of area of 99.00% or more may be included. In this case, it is possible to easily produce the voltage nonlinear resistive material in which the Cu phases and the Cu—Zr compound phases constitute a fibrous structure, and the voltage nonlinear resistive material in which the copper matrix phases and the composite phases constitute a fibrous structure and in which the Cu phases and the Cu—Zr compound phases in each of the composite phases constitute a fibrous structure parallel thereto. The reduction of area is preferably 99.50% or more and more preferably 99.80% or more. The reason for this is that a higher reduction of area results in a smaller structure. The reduction of area may be less than 100.00% and is preferably 99.9999% or less in view of working. The reduction of area used here may be determined as described below. The cross-sectional area of an ingot before the wire drawing in a cross section perpendicular to the drawing direction is determined. After the wire drawing, the cross-sectional area of the resulting wire rod in a cross section perpendicular to the drawing direction is determined. The expression {(cross-sectional area before wire drawing−cross-sectional area after wire drawing)×100}/(cross-sectional area before wire drawing) is calculated. The resulting value is used as the reduction of area (%). The drawing speed is preferably, but not particularly limited to, 10 m/min or more and 200 m/min or less and more preferably 20 m/min or more and 100 m/min or less. The reason for this is that a drawing speed of 10 m/min or more allows the wire drawing to be efficiently performed and that a drawing speed of 200 m/min or less results in further inhibition of a break and so forth during the wire drawing. In the case where the wire drawing is performed, a step of subjecting an ingot to cold wire drawing to a drawing ratio η of 5.0 or more and 12.0 or less may be included. In this case, it is possible to easily produce a voltage nonlinear resistive material in which the short fiber-shaped composite phases are dispersed in the copper matrix phases. The drawing ratio η used here is a value determined from the expression η=ln (A₀/A) where A₀ represents the cross-sectional area (mm²) before the wire drawing, and A represents the cross-sectional area (mm²) after the wire drawing.

A method of rolling is not particularly limited. For example, a method of rolling with at least one pair of upper and lower rollers may be employed. Specific examples thereof include compression rolling and shear rolling. They may be used separately or in combination. The term “compression rolling” used here indicates rolling intended to cause compressive deformation by applying a compressive force to a work being rolled. The term “shear rolling” indicates rolling intended to cause shear deformation by applying a shear force to a work being rolled. As an example of a method of compression rolling, for example, in the case where rolling is performed with a pair of upper and lower rollers, there is a method of rolling such that the coefficients of friction at the contact surface between the upper roller and an ingot and the contact surface between the lower roller and the ingot are both low and are the same level. In this case, for example, it is preferred that the coefficient of friction between the upper roller and the ingot be 0.01 or more and 0.05 or less, the coefficient of friction between the lower roller and the ingot be 0.01 or more and 0.05 or less, and the difference in coefficient of friction between the upper and lower roller sides be 0 or more and 0.02 or less. The rotation speed of the upper roller and the rotation speed of the lower roller are preferably the same level. The compression rolling facilitates uniform rolling deformation and thus provides satisfactory rolling accuracy. As an example of a method of the shear rolling, for example, in the case where rolling is performed with a pair of upper and lower rollers, there is a method of rolling such that a difference in friction state between the contact surface between the upper roller and an ingot and the contact surface between the lower roller and the ingot is created. Examples of a method that creates different friction states include asymmetric rolling in which a pair of upper and lower rollers rotate at different speeds, and a method in which an ingot is rolled in such a manner that the interfaces between the pair of rollers and the ingot have different coefficients of friction. In this case, for example, the coefficient of friction between the upper roller and the ingot is preferably 0.1 or more and 0.5 or less, the coefficient of friction between the lower roller and the ingot is preferably 0.01 or more and 0.2 or less, and the difference in coefficient of friction between the upper and lower roller sides is preferably 0.15 or more and 0.5 or less. Here, in the case that the drive torque (Nm) applied to the rolling rollers is denoted by G, the radius (m) of the rollers is denoted by R, the rolling load (N) is denoted by P, the coefficient of friction μ may be represented by μ=G/RP. The shear rolling provides a uniform lamellar structure, thereby resulting in stable characteristics of the voltage nonlinear resistive element. Furthermore, the shear rolling is particularly suitable for rolling with a high rolling ratio. It is thus possible to reduce the size of the structure by severe plastic deformation. In the compression rolling and the shear rolling, the upper roller and the lower roller may be any rollers that provide the intended friction state. The material and shape of the rollers are not particularly limited. For example, rollers configured to form a flat sheet or rollers configured to form a sheet having a special cross section, for example, an irregular cross section or a tapered cross section, may be used. The rolling pass conditions may be empirically determined. For example, rolling may be repeatedly performed multiple times to a final sheet thickness. In this case, a break is less likely to occur during the rolling. In the case where rolling is performed, a step of subjecting an ingot to cold rolling to a rolling reduction of 99.00% or more may be included. In this case, it is possible to easily produce the voltage nonlinear resistive material in which the Cu phases and the Cu—Zr compound phases constitute a fibrous structure, and the voltage nonlinear resistive material in which the copper matrix phases and the composite phases constitute a fibrous structure and in which the Cu phases and the Cu—Zr compound phases in each of the composite phases constitute a fibrous structure parallel thereto. The rolling reduction is preferably 99.50% or more and more preferably 99.80% or more. The reason for this is that a higher rolling reduction results in a smaller structure. The rolling reduction may be less than 100.00% and preferably 99.99% or less in view of working. The rolling reduction (%) is a value determined by calculating {(sheet thickness before rolling−sheet thickness after rolling)×100}/(sheet thickness before rolling). The rolling speed is preferably, but not particularly limited to, 1 m/min or more and 100 m/min or less and more preferably 5 m/min or more and 20 m/min or less. The reason for this is that a rolling speed of 5 m/min or more allows the rolling to be efficiently performed and that a rolling speed of 20 m/min or less results in further inhibition of a break and so forth during the rolling.

In the processing step, heat treatment may be performed in the course of wire drawing or rolling at a temperature higher than a temperature in the wire drawing or the rolling and 500° C. or lower for 1 second or more and 60 seconds or less. Heating for 1 second or more should provide a strain relief effect, thus facilitating the wire drawing or the rolling. Heating for 60 seconds or less is less likely to lead to recrystallization and recovery. In the case where such heat treatment is performed, cold shearing wire drawing or shear rolling is preferably performed so as to cause shear deformation with a large strain after the heat treatment.

A drawn wire rod or rolled article produced by the foregoing production method may be used as a voltage nonlinear resistive material for direct use in a voltage nonlinear resistive element. A portion of the resulting drawn wire rod or rolled article is taken out and may be used as a voltage nonlinear resistive material for use in a voltage nonlinear resistive element. In this case, for example, only the Cu—Zr compound phase may be taken out. Only the composite phase may be taken out. A portion including both the copper matrix phases and the composite phase may be taken out. As a method for taking out a portion, a chemical method or a mechanical method may be employed.

In the voltage nonlinear resistive element of the present invention, the electrodes are not particularly limited. For example, various electrodes composed of materials, such as Cu, a Cu alloy, Ag, Au, and Pt, may be used. A method for forming the electrodes is not particularly limited. The electrodes may be formed by various methods, such as welding, brazing, and printing. The copper matrix phases and the Cu phase of the voltage nonlinear resistive material may be used as the electrodes. In the case where the voltage nonlinear resistive material has a structure in which the Cu phases and the Cu—Zr compound phases constitute a fibrous structure or lamellar structure or has a structure in which the copper matrix phases and the composite phases constitute a fibrous structure or lamellar structure and in which the Cu phases and the Cu—Zr compound phases in each of the composite phases constitute a fibrous structure or lamellar structure parallel thereto, the electrodes are preferably arranged in parallel with the fibrous structure or lamellar structure formed of the Cu phases and the Cu—Zr compound phases. The reason for this is as follows: In this case, the Cu phases and the Cu—Zr compound phases between the electrodes can be reduced in thickness, compared with the case where the electrode are arranged perpendicularly to the fibrous structure or lamellar structure. Furthermore, the copper matrix phases and the composite phases between the electrodes can be reduced in thickness. As a result, high-resistance regions have relatively small thicknesses. This seemingly allows the mechanism, such as a tunnel effect, to act appropriately. In the case where the voltage nonlinear resistive material is produced by the wire drawing or the rolling, the electrodes are preferably arranged in a direction parallel to a drawing direction or rolling direction. The reason for this is as follows: In the case where the wire drawing or the rolling is performed, for example, the copper matrix phases and the composite phases constitute a fibrous structure or lamellar structure, and the Cu phases and the Cu—Zr compound phases in each of the composite phases constitute a fibrous structure or lamellar structure. The fibrous structure or lamellar structure can be formed in a direction parallel to the drawing direction or the rolling direction. In the case where the electrodes are arranged in the direction parallel to the drawing direction or rolling direction, the high-resistance regions have small thicknesses, thus seemingly allowing the mechanism, such as a tunnel effect, to act appropriately, compared with the case where the electrodes are arranged perpendicularly to the fibrous structure or lamellar structure.

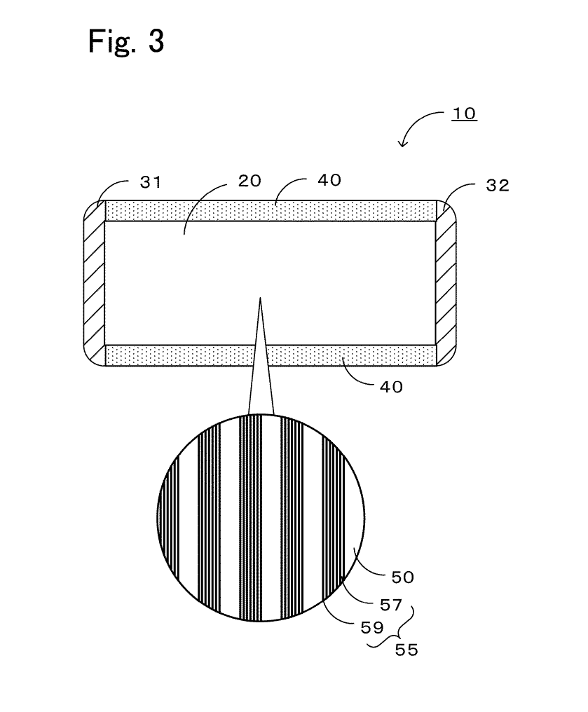

The shape of the voltage nonlinear resistive element of the present invention is not particularly limited. Various shapes, such as a rectangular shape, a stacked shape, a cylindrical shape, and a coiled shape, may be used. FIG. 3 illustrates an example of a voltage nonlinear resistive element of the present invention. In a voltage nonlinear resistive element 10 illustrated in FIG. 3, two electrodes 31 and 32 are arranged so as to be opposite each other with a voltage nonlinear resistive material 20. A portion of a surface of the voltage nonlinear resistive material 20 where the electrodes 31 and 32 are not arranged is covered with an insulating material 40. In the voltage nonlinear resistive material 20, a copper matrix phases 50 and composite phases 55 constitute a fibrous structure, and Cu phases 57 and Cu—Zr compound phases 59 in each of the composite phases 55 constitute a fibrous structure parallel to thereto. The electrodes are arranged in parallel with the fibrous structure. Here, each of the Cu—Zr compound phases 59 is a Cu₉Zr₂ phase. Each of the composite phases 55 is a eutectic phase containing a Cu phase and a Cu₉Zr₂ phase.

The present invention is not limited to the above-described embodiment. It is clear that the present invention can be implemented in a variety of embodiments without departing from the technical scope thereof.

### EXAMPLES

Specific examples in which voltage nonlinear resistive materials used for voltage nonlinear resistive elements of the present invention were produced will be described below as examples. Here, microstructures and phase structures of copper alloys serving as voltage nonlinear resistive materials are exemplified in Experimental Examples 1 to 3. Regarding representative alloys among these alloys, characteristics as voltage nonlinear resistive materials are described in Examples 1 and 2.

### Experimental Example 1

In Experimental Example 1, wire rods (drawn wire rods) were produced, in which copper matrix phases and composite phases constitute a fibrous structure, and Cu phases and Cu—Zr compound phases in each of the composite phases constitute a fibrous structure parallel thereto. Specifically, Cu—Zr binary alloys having Zr contents listed in Table 1 were subjected to levitation melting in an argon gas atmosphere. Pure copper molds each having a round-bar-shaped cavity with a diameter described in Table 1 were coated. A molten metal with a temperature of about 1200° C. was poured and cast into round-bar ingots. The diameters of the ingots were measured with a micrometer and found to be predetermined values. Wire drawing was performed at normal temperature by passing each of the round-bar ingots that had been cooled to room temperature, through 20 to 40 dies having gradually decreasing hole diameters in such a manner that the diameters of the drawn wire rods were values listed in Table 1, thereby producing samples of Experimental Example 1. During the drawing, the drawing speed was 20 m/min. The diameters of the copper alloy wire rods were measured with a micrometer and found to be predetermined values. The dies used for the wire drawing had die holes in the centers thereof and were configured to sequentially pass the ingots through the dies with different hole diameters to perform wire drawing by shearing (hereinafter, the same shall apply).

1. Observation of Casting Structure

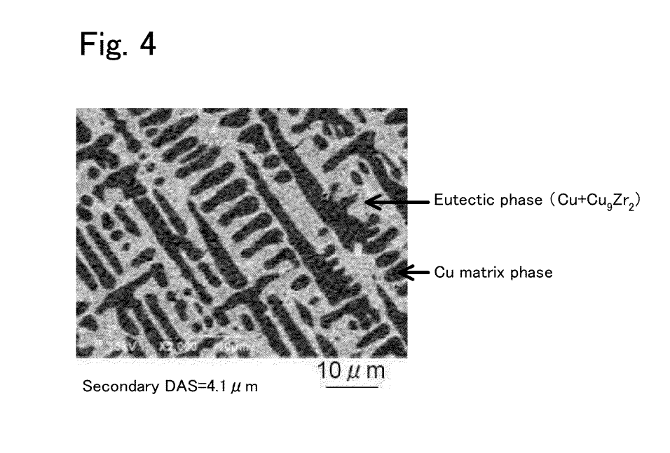

Each of the ingots before the wire drawing was cut in a circular cross section perpendicular to the axial direction, mirror-polished, and observed with a SEM (SU-70, manufactured by Hitachi, Ltd). FIG. 4 is a SEM photograph of the casting structure of a 5-mm-diameter ingot containing 4.0 at % Zr. Portions that appear white indicate composite phases (eutectic phases) formed of Cu phases and Cu—Zr compound phases (Cu₉Zr₂ phases). Portions that appear black indicate proeutectic copper matrix phases. The secondary DAS was measured with the SEM photographs.

2. Observation of Structure after Wire Drawing

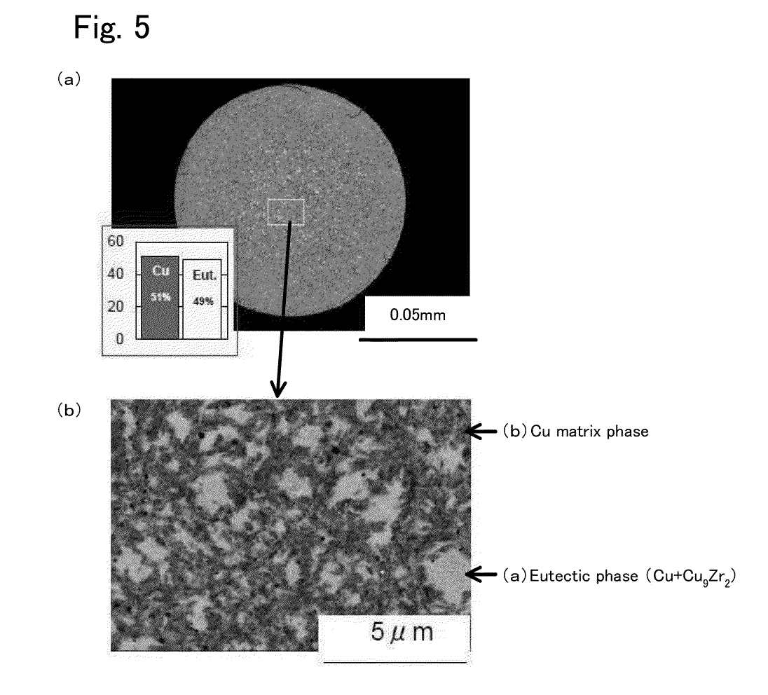

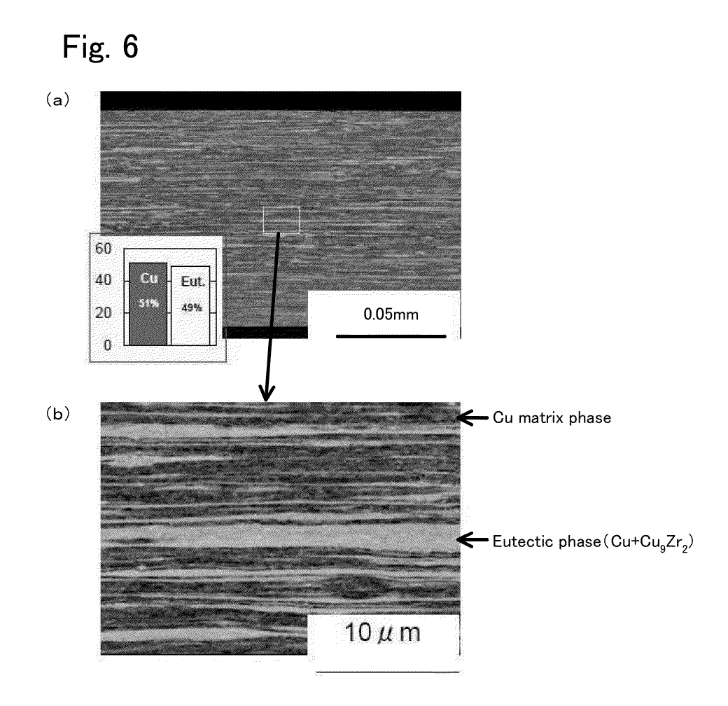

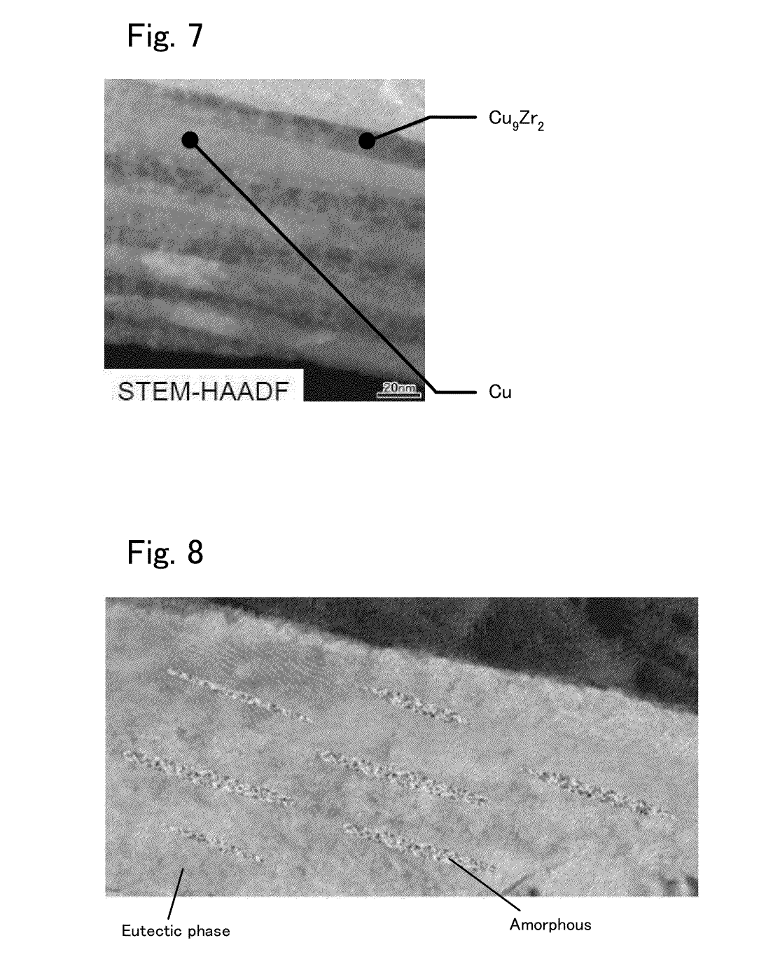

Each of the copper alloy wire rods after the wire drawing was cut in a circular cross section perpendicular to the axial direction, mirror-polished, and observed with a SEM. FIG. 5 illustrates SEM photographs of sample No. 1-6 of the copper alloy wire rod in a circular cross section perpendicular to the axial direction. FIG. 5(b) is a magnified view of the region enclosed by the rectangle in the center of FIG. 5(a). Portions that appear white indicate composite phases. Portions that appear black indicate the copper matrix phases. The black-and-white contrast of the SEM photograph was divided into the copper matrix phases and the composite phases by binarization, and the area proportion of the composite phases was determined as the composite phase proportion. FIG. 6 illustrates SEM photographs of sample No. 1-6 of the copper alloy wire rod in a circular cross section parallel to the axial direction and including the central axis. FIG. 6(b) is a magnified view of the region enclosed by the rectangle in the center of FIG. 6(a). Portions that appear white indicate composite phases. Portions that appear black indicate the copper matrix phases. They were alternately arranged to form a fibrous structure extending in one direction. In this regard, the analysis of the field of view in FIG. 6 by energy dispersive X-ray spectroscopy (EDX) revealed that the portions that appear black were matrix phases composed only of copper and the portions that appear white were composite phases containing copper and zirconium. Next, the phase thicknesses of the Cu phases and the Cu—Zr compound phases were measured with a STEM as described below. A wire rod thinned by Ar ion milling was prepared as a sample for STEM observation. The central region, serving as a representative region, was observed at a magnification of ×500,000. Scanning electron microscopy high-angle annular dark-field images (STEM-HAADF images) were captured in three fields of view with a size of 300 nm×300 nm. The widths of the phases in the STEM-HAADF images were measured. The average thereof was calculated as the measured phase thickness. FIG. 7 is an STEM photograph, taken with a STEM (JEM-2300F, manufactured by JEOL Ltd.), of a portion that appears white (in the composite phase) in FIG. 6. An EDX analysis estimated that the white portions were Cu phases and that the black portions were Cu₉Zr₂ phases. The presence of the Cu₉Zr₂ phases was confirmed by analyzing a diffraction image using a selected-area diffraction method and measuring the lattice parameters of a plurality of diffraction planes. The results demonstrated that the composite phase in FIG. 7 had a double fibrous structure in which the Cu phases and the Cu—Zr compound phases were alternately arranged, each of the Cu phases and the Cu—Zr compound phases having a thickness of about 20 nm. STEM observation of the lattice image of the composite phase illustrated in FIG. 7 revealed that amorphous phases having an area proportion of about 15% in the field of view (in the composite phase) were observed. FIG. 8 is a schematic view of the amorphous phases in the composite phase. The amorphous phases were mainly formed at the interfaces between the Cu phases and the Cu—Zr compound phases. The amorphous proportion was determined by measuring the area proportion of possible amorphous regions where atoms were randomly arranged in the lattice image. When the Cu structure that appears white in FIG. 7 was observed with the STEM, the difference in orientation between the adjacent fine crystals was about 1° to about 2°, which was significantly small. This suggests that large shear slip deformation caused in Cu in the drawing direction without accumulation of dislocations. This seemingly allows wire drawing at a high drawing ratio without causing a break during the cold working.

3. Discussion

Table 1 lists the composition, the casting diameter, the secondary DAS, the drawing diameter, the reduction of area, the composite phase proportion, the phase thickness, and the amorphous proportion of each of the samples of Experimental Example 1 (sample Nos. 1-1 to 1-35). Table 1 demonstrated that when the Zr content, the reduction of area, the composite phase proportion, and the amorphous proportion were increased, the phase thickness tended to decrease. Sample No. 1-29 having a Zr content of 7.4 at % or more was broken in the course of the wire drawing. In sample No. 1-30 and 1-33 to 1-35 having a Zr content of 8.6 at % or more, the wire drawing was not able to be performed. It was thus found that the Zr content was preferably less than 8.6 at % and more preferably less than 7.4 at % in view of processability.

TABLE 1

| | | | | Wire drawing step | | | | |
|---|---|---|---|---|---|---|---|---|
| | Melting and casting step | | | | | Composite | | |
| | | Casting | Secondary | Drawing | Reduction | phase | Phase | Amorphous |
| | Composition | diameter | DAS¹⁾ | diameter | of area | proportion²⁾ | thickness³⁾ | proportion⁴⁾ |
| Sample | at % (Zr) | mm | μm | mm | % | % | nm | % |
| No. 1-1 | 3.0 | 3 | 3.2 | 0.300 | 99.0000 | 40 | 50 | 6 |
| No. 1-2 | 3.0 | 3 | 3.2 | 0.100 | 99.8889 | 43 | 50 | 7 |
| No. 1-3 | 3.0 | 3 | 3.2 | 0.040 | 99.9822 | 44 | 50 | 7 |
| No. 1-4 | 3.0 | 3 | 3.2 | 0.010 | 99.9989 | 44 | 50 | 9 |
| No. 1-5 | 4.0 | 3 | 1.9 | 0.300 | 99.0000 | 46 | 40 | 5 |
| No. 1-6 | 4.0 | 3 | 1.9 | 0.100 | 99.8889 | 49 | 20 | 11 |
| No. 1-7 | 4.0 | 3 | 1.9 | 0.040 | 99.9822 | 49 | 20 | 10 |
| No. 1-8 | 4.0 | 3 | 1.9 | 0.010 | 99.9989 | 48 | 30 | 12 |
| No. 1-9 | 4.0 | 3 | 1.9 | 0.008 | 99.9993 | 50 | 20 | 13 |
| No. 1-10 | 4.0 | 5 | 4.1 | 0.100 | 99.9600 | 49 | 40 | 15 |
| No. 1-11 | 4.0 | 5 | 4.1 | 0.040 | 99.9936 | 50 | 40 | 22 |
| No. 1-12 | 4.0 | 5 | 4.1 | 0.010 | 99.9996 | 50 | 30 | 24 |
| No. 1-13 | 4.0 | 5 | 4.1 | 0.008 | 99.9997 | 51 | 20 | 24 |
| No. 1-14 | 4.0 | 7 | 6.1 | 0.100 | 99.9796 | 47 | 50 | 17 |
| No. 1-15 | 4.0 | 7 | 6.1 | 0.040 | 99.9967 | 48 | 50 | 18 |
| No. 1-16 | 4.0 | 7 | 6.1 | 0.010 | 99.9998 | 48 | 40 | 18 |
| No. 1-17 | 4.0 | 10 | 9.4 | 0.100 | 99.9900 | 44 | 50 | 10 |
| No. 1-18 | 4.0 | 10 | 9.4 | 0.040 | 99.9984 | 45 | 40 | 10 |
| No. 1-19 | 4.0 | 10 | 9.4 | 0.010 | 99.9999 | 47 | 40 | 12 |
| No. 1-20 | 5.0 | 3 | 1.7 | 0.300 | 99.0000 | 54 | 50 | 15 |
| No. 1-21 | 5.0 | 3 | 1.7 | 0.100 | 99.8889 | 55 | 30 | 23 |
| No. 1-22 | 5.0 | 3 | 1.7 | 0.040 | 99.9822 | 56 | 20 | 23 |
| No. 1-23 | 5.0 | 3 | 1.7 | 0.010 | 99.9989 | 57 | 20 | 25 |
| No. 1-24 | 6.8 | 3 | 1.6 | 0.300 | 99.0000 | 53 | 30 | 15 |
| No. 1-25 | 6.8 | 3 | 1.6 | 0.100 | 99.8889 | 55 | 20 | 22 |
| No. 1-26 | 6.8 | 3 | 1.6 | 0.040 | 99.9822 | 57 | 20 | 24 |
| No. 1-27 | 6.8 | 3 | 1.6 | 0.010 | 99.9989 | 60 | 20 | 25 |
| No. 1-28 | 2.5 | 3 | 4.2 | 0.100 | 99.8889 | 32 | 120 | 3 |
| No. 1-29 | 7.4 | 3 | 1.6 | 0.100 | Broken | — | — | — |
| No. 1-30 | 8.7 | 7 | * | Wire drawing | — | — | — | — |
| | | | | was not able to | | | | |
| | | | | be performed | | | | |
| No. 1-31 | 4.0 | 12 | 10.8 | 0.600 | 99.7500 | 33 | 80 | 4 |
| No. 1-32 | 4.0 | 7 | 6.1 | 0.800 | 98.6939 | 38 | 70 | 4 |
| No. 1-33 | 8.6 | 12 | * | Wire drawing | — | — | — | — |
| | | | | was not able to | | | | |
| | | | | be performed | | | | |
| No. 1-34 | 12.0 | 12 | * | Wire drawing | — | — | — | — |
| | | | | was not able to | | | | |
| | | | | be performed | | | | |
| No. 1-35 | 18.0 | 12 | * | Wire drawing | — | — | — | — |
| | | | | was not able to | | | | |
| | | | | be performed | | | | |

¹⁾The secondary dendrite arm spacing.
²⁾The area proportion of the composite phases in the entire wire rod when a cross section perpendicular to the axial direction was observed.
³⁾The average value of the widths of the Cu phases and the Cu—Zr compound phases in the composite phases when a cross section parallel to the axial direction and including the central axis was observed.
⁴⁾The area proportion of the amorphous phases in the composite phases when a cross section parallel to the axial direction and including the central axis was observed.
* The secondary DAS was not able to be measured because No. 1-33 consisted of the composite phases (eutectic phases) and No. 1-30, 1-34, and 1-35 consisted of the composite phases and the Cu—Zr compound phases.

### Experimental Example 2

In Experimental Example 2, sheet (foil) articles (rolled articles) were produced, in which copper matrix phases and composite phases constitute a fibrous structure, and Cu phases and Cu—Zr compound phases in each of the composite phases constitute a fibrous structure parallel thereto. Specifically, Cu—Zr binary alloys having compositions listed in Table 2 were subjected to levitation melting in an argon gas atmosphere. Pure copper molds each having a cavity with a size of 80 mm×80 mm were coated. A molten metal with a temperature of about 1200° C. was poured and cast into sheet-shaped ingots with sheet thicknesses listed in Table 2. The thicknesses of the ingots were checked by measuring the thicknesses with a micrometer. The sheet-shaped ingots that had been cooled to room temperature were subjected to shear rolling at normal temperature in such a manner that the thicknesses of rolled articles were values listed in Table 2, thereby producing samples of Experimental Example 2. During the rolling, the rolling speed was 5 m/min. The thicknesses of the resulting copper alloy foil pieces were checked by measuring the thicknesses with a micrometer.

1. Observation of Casting Structure

Each of the ingots before the rolling were cut in a cross section perpendicular to a sheet surface, mirror-polished, and observed with a SEM. The same structure as that in Experimental Example 1 (for example, FIG. 4) was observed.

2. Observation of Structure after Rolling

Each of the copper alloy foil pieces after the rolling was cut in a cross section which was located at the center of the sheet width and which is perpendicular to the width direction. The structure in Experimental Example 2 after the rolling was observed in the same way as in the observation of the structure of Experimental Example 1 after the wire drawing. The same structure as that in Experimental Example 1 (for example, FIGS. 6 to 8) was observed.

3. Discussion

Table 2 lists the composition, the casting thickness, the secondary DAS, the foil thickness, the rolling reduction, the composite phase proportion, the phase thickness, and the amorphous proportion of each of the samples of Experimental Example 2 (sample Nos. 2-1 to 2-28). Table 2 demonstrated that when the Zr content, the rolling reduction, the composite phase proportion, and the amorphous proportion were increased, the phase thickness tended to decrease. Sample No. 2-25 having a Zr content of 7.4 at % or more was broken in the course of the rolling. In sample No. 2-26 having a Zr content of 8.7 at % or more, the rolling was not able to be performed. It was thus found that the Zr content was preferably less than 8.6 at % and more preferably less than 7.4 at % in view of processability, as with Experimental Example 1.

TABLE 2

| | | | | Rolling step | | | | |
|---|---|---|---|---|---|---|---|---|
| | Melting and casting step | | | | | Composite | | |
| | | | Secondary | Foil | Rolling | phase | Phase | Amorphous |
| | Composition | Thickness | DAS¹⁾ | thickness | reduction | proportion²⁾ | thickness³⁾ | proportion⁴⁾ |
| Sample | at % (Zr) | mm | μm | mm | % | % | nm | % |
| No. 2-1 | 3.0 | 3 | 3.1 | 0.025 | 99.17 | 40 | 50 | 6 |
| No. 2-2 | 3.0 | 3 | 3.1 | 0.015 | 99.50 | 43 | 50 | 7 |
| No. 2-3 | 3.0 | 3 | 3.1 | 0.010 | 99.67 | 44 | 50 | 9 |
| No. 2-4 | 4.0 | 3 | 2.2 | 0.015 | 99.50 | 43 | 40 | 5 |
| No. 2-5 | 4.0 | 3 | 2.2 | 0.010 | 99.67 | 45 | 30 | 11 |
| No. 2-6 | 4.0 | 3 | 2.2 | 0.008 | 99.73 | 50 | 20 | 13 |
| No. 2-7 | 4.0 | 5 | 4.6 | 0.050 | 99.00 | 47 | 40 | 12 |
| No. 2-8 | 4.0 | 5 | 4.6 | 0.025 | 99.50 | 48 | 30 | 15 |
| No. 2-9 | 4.0 | 5 | 4.6 | 0.010 | 99.80 | 50 | 30 | 16 |
| No. 2-10 | 4.0 | 5 | 4.6 | 0.008 | 99.84 | 52 | 20 | 22 |
| No. 2-11 | 4.0 | 7 | 6.3 | 0.050 | 99.29 | 44 | 50 | 16 |
| No. 2-12 | 4.0 | 7 | 6.3 | 0.025 | 99.64 | 44 | 50 | 18 |
| No. 2-13 | 4.0 | 7 | 6.3 | 0.010 | 99.86 | 47 | 40 | 19 |
| No. 2-14 | 4.0 | 10 | 9.7 | 0.050 | 99.50 | 42 | 50 | 10 |
| No. 2-15 | 4.0 | 10 | 9.7 | 0.025 | 99.75 | 43 | 40 | 11 |
| No. 2-16 | 4.0 | 10 | 9.7 | 0.010 | 99.90 | 46 | 40 | 10 |
| No. 2-17 | 5.0 | 5 | 4.3 | 0.050 | 99.00 | 49 | 50 | 15 |
| No. 2-18 | 5.0 | 5 | 4.3 | 0.025 | 99.50 | 52 | 30 | 19 |
| No. 2-19 | 5.0 | 5 | 4.3 | 0.010 | 99.80 | 54 | 20 | 23 |
| No. 2-20 | 5.0 | 5 | 4.3 | 0.008 | 99.84 | 55 | 20 | 25 |
| No. 2-21 | 6.8 | 5 | 3.2 | 0.050 | 99.00 | 51 | 50 | 15 |
| No. 2-22 | 6.8 | 5 | 3.2 | 0.025 | 99.50 | 53 | 40 | 22 |
| No. 2-23 | 6.8 | 5 | 3.2 | 0.010 | 99.80 | 60 | 30 | 24 |
| No. 2-24 | 2.5 | 5 | 9.7 | 0.050 | 99.00 | 33 | 130 | 3 |
| No. 2-25 | 7.4 | 5 | 2.3 | 0.050 | Broken | — | — | — |
| No. 2-26 | 8.7 | 7 | * | Rolling was | — | — | — | — |
| | | | | not able to | | | | |
| | | | | be | | | | |
| | | | | performed | | | | |
| No. 2-27 | 4.0 | 12 | 10.9 | 0.600 | 95.00 | 34 | 110 | 4 |
| No. 2-28 | 4.0 | 3 | 2.2 | 0.050 | 98.33 | 39 | 100 | 4 |

¹⁾The secondary dendrite arm spacing.
²⁾The area proportion of the composite phases in the entire sheet when a cross section perpendicular to the width direction was observed.
³⁾The average value of the widths of the Cu phases and the Cu—Zr compound phases in the composite phases when a cross section parallel to the width direction and including the central axis was observed.
⁴⁾The area proportion of the amorphous phases in the composite phases when a cross section parallel to the width direction and including the central axis was observed.
* The secondary DAS was not able to be measured because No. 2-26 consisted of the composite phases (eutectic phases).

### Experimental Example 3

In Experimental Example 3, wire rods in which short-fiber-shaped composite phases were dispersed in copper matrix phases were produced. Specifically, raw materials were weighed so as to form Cu—Zr binary alloys each having a Zr content listed in Table 3. The raw materials were charged into a silica tube. High-frequency induction melting was performed in a chamber filled with Ar gas. A molten metal obtained by sufficient melting was poured into a pure copper mold and cast into round-bar ingots 12 mm in diameter. Each of the round-bar ingots was cooled to room temperature and then subjected to facing to a diameter of 11 mm, thereby removing unevenness of the casting surface. Wire drawing was performed at normal temperature by passing each of the resulting ingots through 20 to 40 dies having gradually decreasing hole diameters in such a manner that the diameters (drawing diameters) of the drawn wire rods were values listed in Table 3, thereby producing the wire rods of Experimental Example 3.

1. Observation of Structure after Wire Drawing

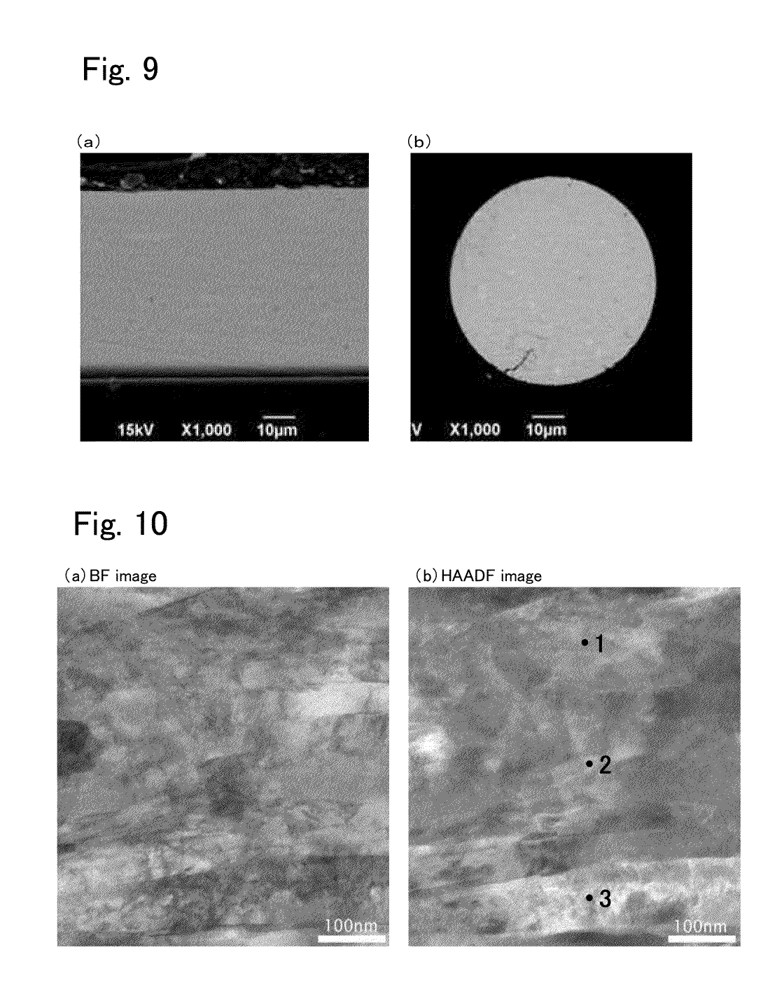

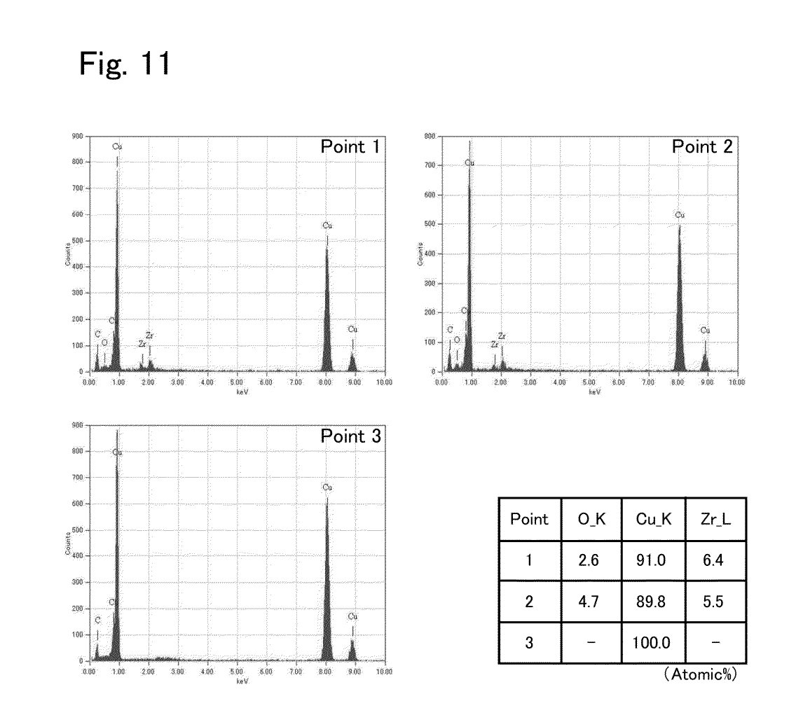

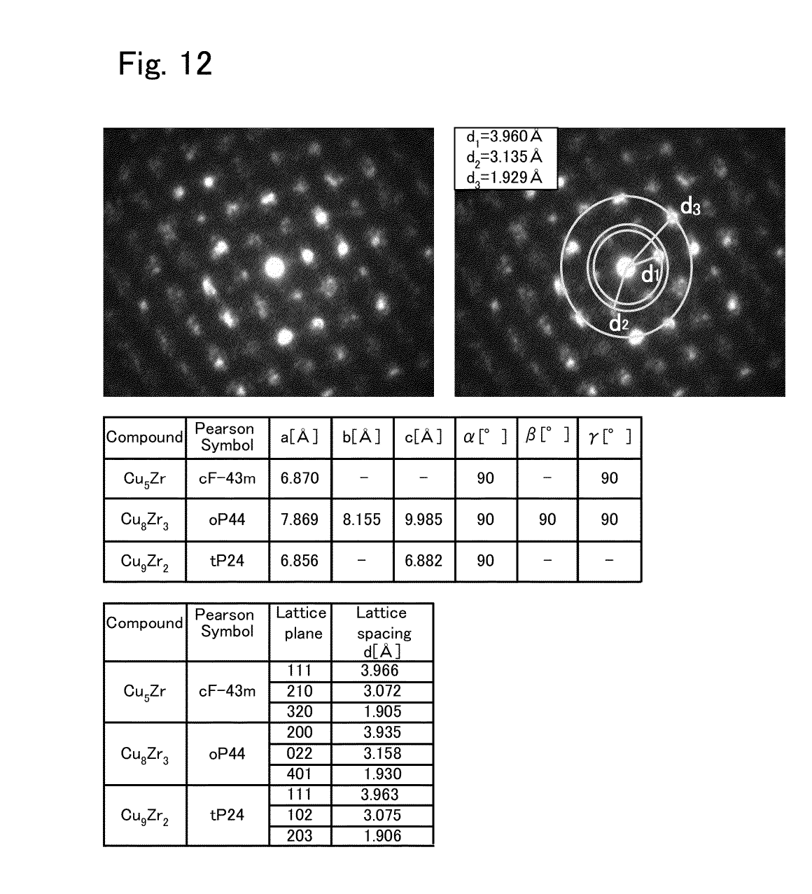

Each of the copper alloy wire rods after the wire drawing was cut in a circular cross section perpendicular to the axial direction, mirror-polished, and observed with a SEM. FIG. 9 illustrates SEM photographs of sample No. 3-12, (a) illustrates a longitudinal section, and (b) illustrates a cross section. In FIG. 9, portions that appear white indicate composite phases. Portions that appear black indicate the copper matrix phases. In sample No. 3-12, the short fiber-shaped composite phases were dispersed in the copper matrix phases. FIG. 10 illustrates a bright-field image (BF image) and a high-angle annular dark-field image (HAADF image) of the composite phases of sample No. 3-12 with a STEM. FIG. 11 illustrates EDX analysis results at points (1 to 3) in FIG. 10. The EDX analysis results demonstrated that Points 1 and 2 were located in the Cu—Zr compound phases and Point 3 was located in the Cu phase. FIG. 12 illustrates NBD analysis results at Point 2 (Cu—Zr compound) in FIG. 10. The results demonstrated that lattice constants were determined from typical three diffraction patterns other than the diffraction pattern of Cu and found that d₁=3.960 Å, d₂=3.135 Å, and d₃=1.929 Å. These lattice constants were matched (differences were within ±0.05 Å) to the lattice spacings of the (200) plane, the (022) plane, and the (401) plane, respectively, of Cu₈Zr₃. Meanwhile, they were not matched to the lattice spacings of Cu₉Zr₂ or Cu₅Zr, which were possibly contained in the composite phases. The results demonstrated that the composite phases contained Cu and Cu₈Zr₃.

2. Discussion

Table 3 lists the composition, the drawing diameter, the drawing ratio η, the area proportion of the composite phases, and the aspect ratio of each composite phase of each of the samples of Experimental Example 3 (sample Nos. 3-1 to 3-18). Table 3 demonstrated that the area proportion of the composite phases was little affected by the wire drawing ratio η and varied with the Zr content. The aspect ratio of each composite phase was increased as the wire drawing ratio η was increased. It was assumed that the Cu₈Zr₃ phases contained in the composite phases were produced by, for example, changing the crystal structure of the Cu₉Zr₂ phases or the like by the processing.

TABLE 3

| | | Wire drawing step | | | |
|---|---|---|---|---|---|
| | | | | Composite phase | |
| | Casting step | Drawing | Drawing | Area | Aspect |
| | Composition | diameter | ratio η | proportion | ratio L/T |
| Sample | at % (Zr) | mm | — | % | — |
| No. 3-1 | 0.20 | 0.04 | 11.2 | 0.50-1.00 | 9.2 |
| No. 3-2 | 0.20 | 0.027 | 12.0 | 0.50-1.00 | 10.0 |
| No. 3-3 | 0.36 | 0.06 | 10.4 | 0.50-1.00 | 8.6 |
| No. 3-4 | 0.50 | 0.06 | 10.4 | 1.0-2.5 | 9.0 |
| No. 3-5 | 0.50 | 0.10 | 9.4 | 1.0-2.5 | 8.4 |
| No. 3-6 | 0.50 | 0.20 | 8.0 | 1.0-2.5 | 6.2 |
| No. 3-7 | 0.50 | 0.50 | 6.2 | 1.0-2.5 | 3.2 |
| No. 3-8 | 0.50 | 0.90 | 5.0 | 1.0-2.5 | 1.5 |
| No. 3-9 | 0.83 | 0.10 | 9.4 | 2.5-5.0 | 4.6 |
| No. 3-10 | 1.00 | 0.03 | 11.8 | 2.5-5.0 | 8.3 |
| No. 3-11 | 1.00 | 0.04 | 11.2 | 2.5-5.0 | 7.9 |
| No. 3-12 | 1.00 | 0.06 | 10.4 | 2.5-5.0 | 7.7 |
| No. 3-13 | 1.00 | 0.08 | 9.8 | 2.5-5.0 | 7.3 |
| No. 3-14 | 1.00 | 0.20 | 8.0 | 2.5-5.0 | 6.6 |
| No. 3-15 | 0.18 | 0.10 | 9.4 | 5-10 | 2.2 |
| No. 3-16 | 1.08 | 0.20 | 8.0 | 5-10 | 17.9 |
| No. 3-17 | 2.00 | 0.06 | 10.4 | 5-10 | 20.1 |
| No. 3-18 | 0.50 | 1.00 | 4.8 | 1.0-2.5 | 1.3 |

### Example 1

### 1. Production of Voltage Nonlinear Resistive Material

In Example 1, as with Experimental Example 1, a wire rod was produced, in which copper matrix phases and composite phases constitute a fibrous structure, and Cu phases and Cu—Zr compound phases in each of the composite phases constitute a fibrous structure parallel thereto. A Cu—Zr binary alloy containing 5.0 at % Zr and the balance being Cu was melted in a silica tube in an Ar gas atmosphere. A pure copper mold having a round-bar-shaped cavity with a diameter of 3 mm was coated. A molten metal with a temperature of about 1200° C. was poured and cast into a round-bar ingot. Wire drawing was performed at normal temperature by passing the round-bar ingot that had been cooled to room temperature, through 20 to 40 dies having gradually decreasing hole diameters in such a manner that the diameter of the drawn wire rod was 0.160 mm, thereby producing the wire rod of Example 1. During the drawing, the drawing speed was 20 m/min.

### 2. Shape Measurement and Current Distribution Measurement

AFM-current simultaneous measurement was performed with E-Sweep and NanoNavi manufactured by SII. The shape was measured by scanning a probe in an atomic force microscope (AFM) mode while the probe was in contact. The current distribution was measured by scanning in a current imaging tunneling spectroscopy (CITS) mode.

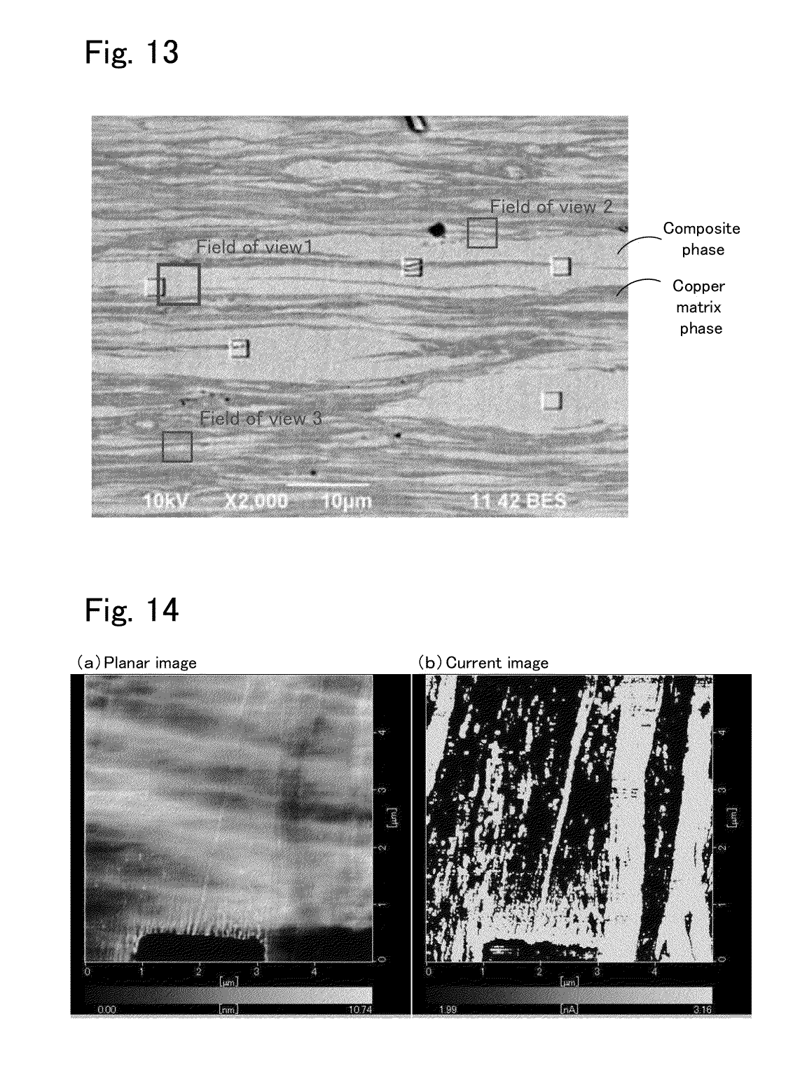

FIG. 13 is a SEM composition image of the wire rod of Example 1 in a cross section obtained by cutting the wire rod in a direction parallel to the drawing direction. Portions that appear white indicate the composite phases containing the Cu phases and the Cu—Zr compound phases. Portions that appear black indicate the copper matrix phases. The SEM composition image demonstrated that in the wire rod of Example 1, the copper matrix phases and the composite phases had a fibrous structure. Furthermore, STEM observation revealed that in the composite phases, the Cu phases and the Cu—Zr compound phases had a fibrous structure (not illustrated). Square marks scattered on the SEM composition image were formed by focused ion beam (F1B) processing.

FIG. 14 illustrates a planar image and a current image in field of view 1 in FIG. 13. The planar image and the current image were turned to the left by 90° with respect to the SEM composition image (hereinafter, the same shall apply). Particularly bright portions in the planar image were not matched to particularly bright portions in the current image. This demonstrated that the irregularities of the surface of the sample did not affect the current value. In the current image, the copper matrix phase portions in the SEM composition image appeared bright, and the composite phase portions appeared dark. This demonstrated that a large amount of current passed through the copper matrix phases and that a current was less likely to pass through the composite phases. In the measurement illustrated in FIG. 14, the measurement was performed by applying a DC bias of 1.0 V to the field of view with a size of 5 μm×5 μm.

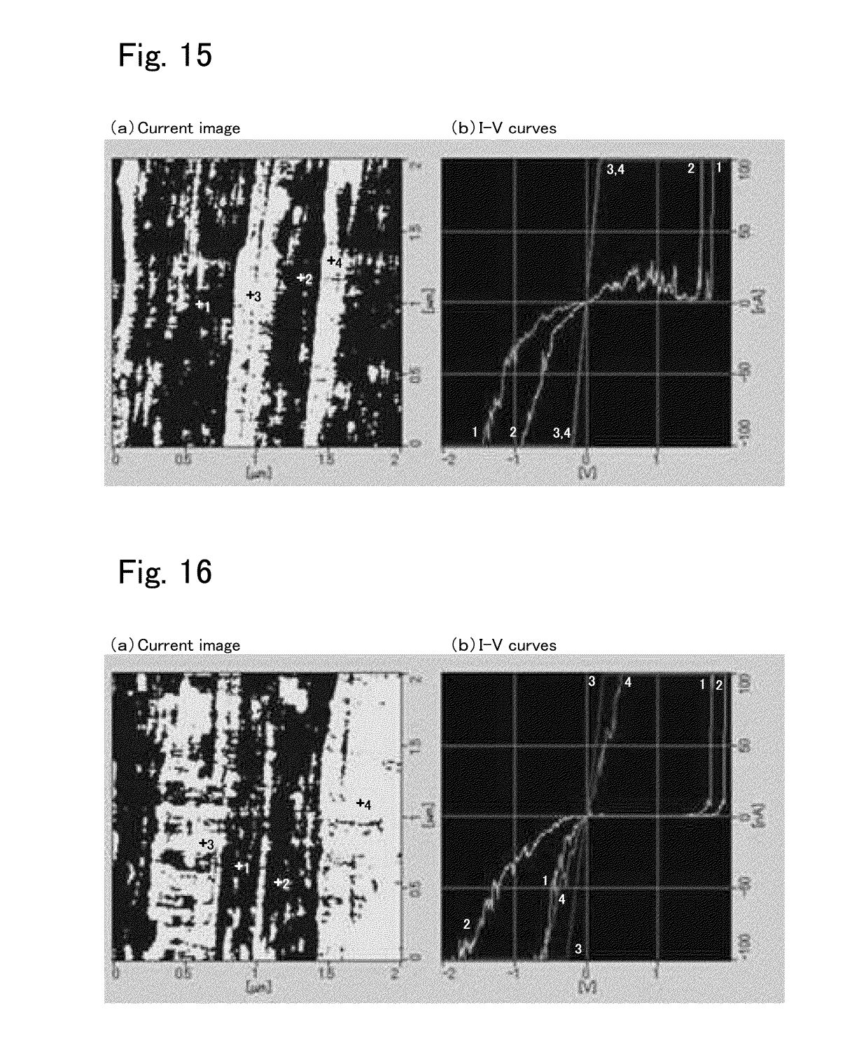

FIGS. 15 and 16 illustrate current images in fields of view 2 and 3 of the wire rod of Example 1 and I-V curves at points in the current image. FIGS. 15 and 16 demonstrated that the voltage nonlinear resistive characteristics were exhibited in the composite phases that appeared black in the current images, i.e., at Points 1 and 2. In the measurement illustrated in FIGS. 15 and 16, regarding the fields of view with a size of 2 μm×2 μm, the current images were measured by the application of a DC bias of 0.3 V, and the I-V curves were measured by the application of different bias voltages of −2.0 V to 2.0 V.

### Example 2

### 1. Production of Voltage Nonlinear Resistive Material

In Example 2, as with Experimental Example 3, a wire rod in which short-fiber-shaped composite phases were dispersed in copper matrix phases was produced. Raw materials were weighed so as to form a Cu—Zr binary alloy containing 0.5 at % Zr and the balance being Cu. The raw materials were charged into a silica tube. High-frequency induction melting was performed in a chamber filled with Ar gas. A molten metal obtained by sufficient melting was poured into a pure copper mold and cast into a 12-mm-diameter round-bar ingot. Next, the round-bar ingot was cooled to room temperature and then subjected to facing to a diameter of 11 mm, thereby removing unevenness of the casting surface. Wire drawing was performed at normal temperature by passing the resulting ingot through 20 to 40 dies having gradually decreasing hole diameters in such a manner that the diameter (drawing diameter) of the drawn wire rod was 90 μm, thereby producing the wire rod of Example 2.

### 2. Shape Measurement and Current Distribution Measurement

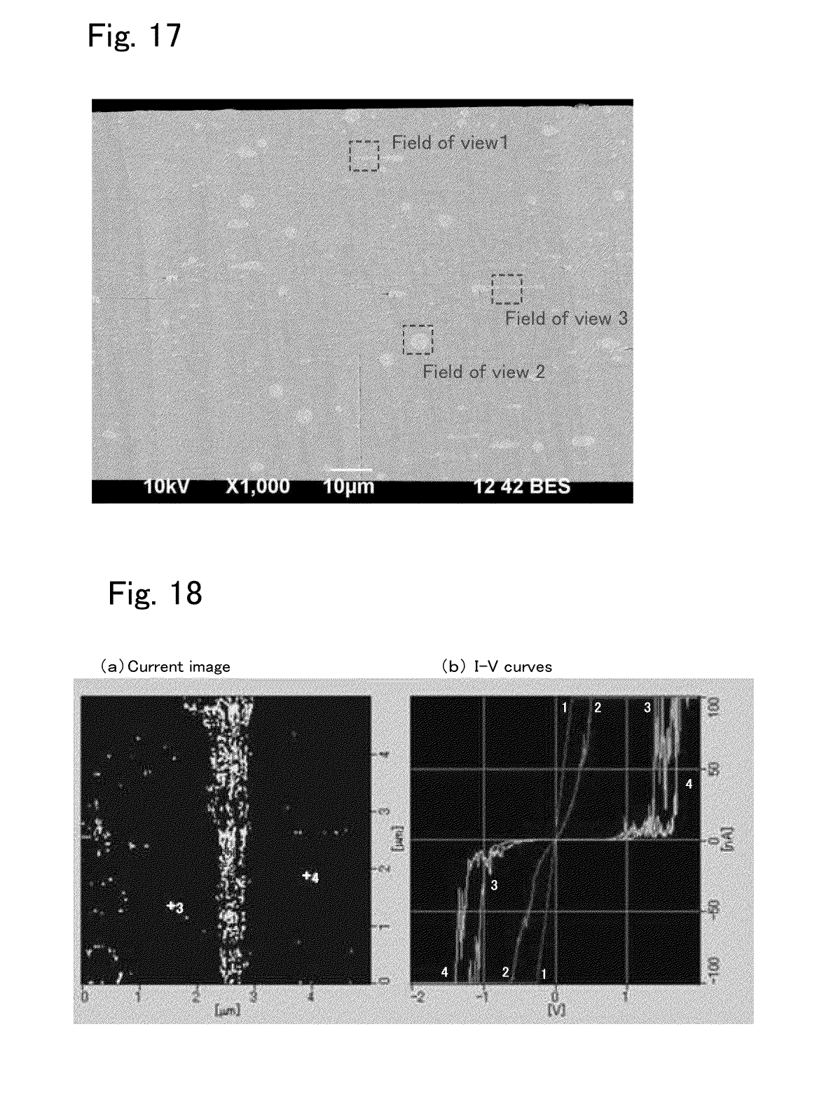

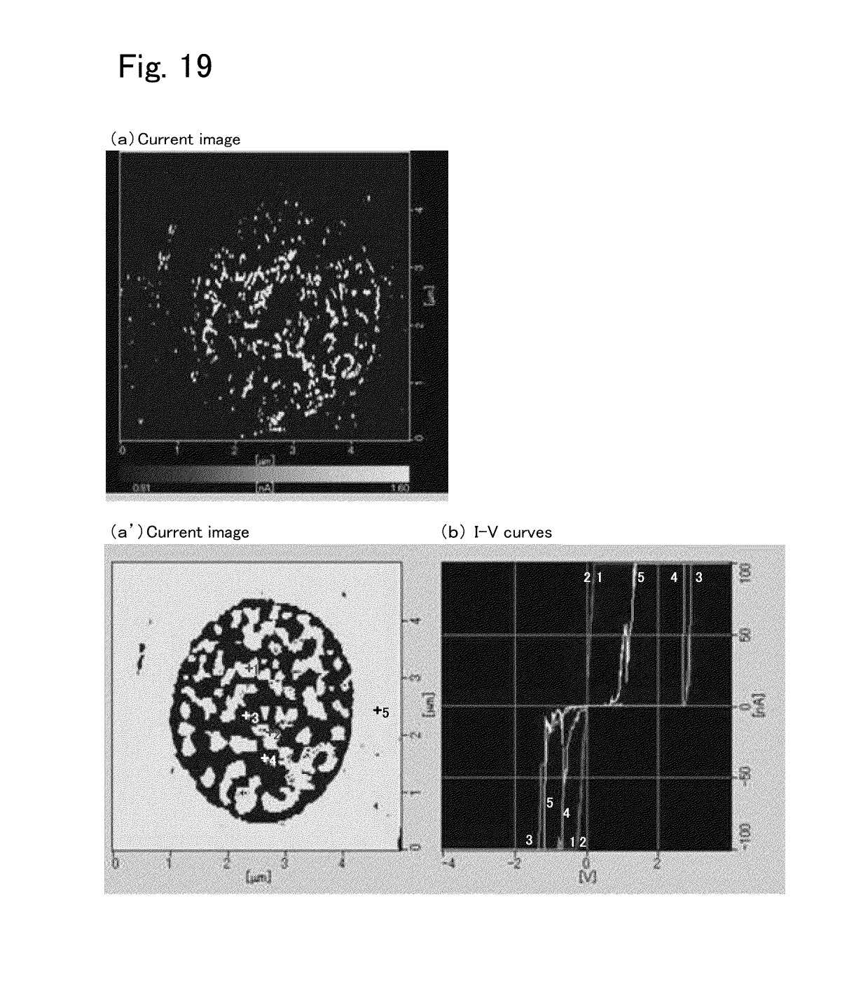

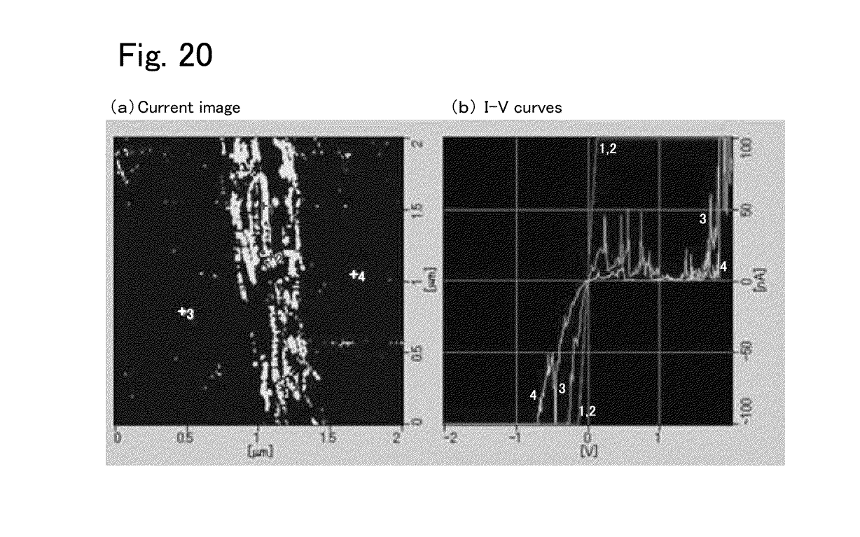

Measurements were performed in the same way as in Example 1. FIG. 17 is a SEM composition image of the wire rod of Example 2 in a cross section obtained by cutting the wire rod in a direction parallel to the drawing direction. FIG. 18 illustrates a current image in field of view 1 in FIG. 17 and I-V curves at points in the current image. In the current image in FIG. 18(a), the Cu phases in the composite phases appeared brighter than the copper matrix phases. The reason for this is presumably that different contact states between a probe and the sample were caused by the effect of the irregularities of the sample surface. In field of view 1, the voltage nonlinear resistive characteristics were exhibited at Points 3 and 4 in the copper matrix phases that appeared white in the SEM composition image. This suggested that Zr was present in the copper matrix phases and that the voltage nonlinear resistive characteristics were possibly exhibited. In field of view 1, Points 1 and 2 at which the voltage nonlinear resistive characteristics were not exhibited were located in the Cu phases in the composite phases. In the measurement illustrated in FIG. 18, regarding the field of view with a size of 5 μm×5 μm, the current image was measured by the application of a DC bias of 0.4 V, and the I-V curve was measured by the application of different bias voltages of −2.0 V to 2.0 V. FIG. 19 illustrates current images in field of view 2 illustrated in FIG. 17 and I-V curves at points in the current image. In field of view 2, the voltage nonlinear resistive characteristics were also exhibited at Point 5, which was located in the copper matrix phases determined from the SEM composition image. In addition, the voltage nonlinear resistive characteristics were also exhibited at Points 3 and 4 in the Cu—Zr compound phases although a current started flowing at different voltages. In field of view 2, Points 1 and 2 at which the voltage nonlinear resistive characteristics were not exhibited were located in the Cu phases in the composite phases. In the measurement illustrated in FIG. 19, regarding the field of view with a size of 5 μm×5 μm, the current image illustrated in (a) was measured by the application of a DC bias of 0.3 V. The current image illustrated in (a′) was measured by the application of a DC bias of 1.0 V. The I-V curves were measured by the application of different bias voltages of −4.0 V to 4.0 V. FIG. 20 illustrates a current image in the field of view 3 illustrated in FIG. 17 and I-V curves at points of the current image. In field of view 3, the same results as in field of view 1 were obtained. In the measurement illustrated in FIG. 20, regarding the field of view with 2 μm×2 μm, the current image was measured by the application of a DC bias of 0.3 V, and the I-V curves were measured by the application of different bias voltages of −2.0 V to 2.0 V.

(Discussion)

The results described above demonstrated that the copper alloys including the Cu—Zr compound phases exhibited the voltage nonlinear resistive characteristics and were usable to voltage nonlinear resistive elements. It was also found that a current started flowing at a relatively low voltage. The wire rods of Examples 1 and 2 exhibited the voltage nonlinear resistive characteristics. Thus, in the case of at least the wire rods of Experimental Example 1 and the sheet articles of Experimental Example 2 which had the same composition and structure as those of Example 1 and the wire rods of Experimental Example 3 which had the same composition and structure as those of Example 2, the voltage nonlinear resistive characteristics were presumably exhibited, as with Examples 1 and 2.

The present application claims priority from Japanese Patent Application No. 2012-225160 filed on Oct. 10, 2012, the entire contents of which are incorporated herein by reference.

### INDUSTRIAL APPLICABILITY

The present invention is applicable to the field of electronic equipment.

What is claimed is:

1. A voltage nonlinear resistive element comprising:
a voltage nonlinear resistive material composed of a copper alloy containing a Cu—Zr compound phase; and
electrodes.

2. The voltage nonlinear resistive element according to claim 1, wherein in the voltage nonlinear resistive material, the Cu—Zr compound phase contains at least one of a Cu₉Zr₂ phase, a Cu₅Zr phase, and a Cu₈Zr₃ phase.

3. The voltage nonlinear resistive element according to claim 1, wherein the voltage nonlinear resistive material comprises a composite phase that contains a Cu phase and the Cu—Zr compound phase.

4. The voltage nonlinear resistive element according to claim 3, wherein in the voltage nonlinear resistive material, the composite phase is a eutectic phase containing the Cu phase and the Cu₉Zr₂ phase.

5. The voltage nonlinear resistive element according to claim 3, wherein the voltage nonlinear resistive material contains a copper matrix phase in addition to the composite phase.

6. The voltage nonlinear resistive element according to claim 3, wherein in the composite phase of the voltage nonlinear resistive material, the Cu phase and the Cu—Zr compound phase constitute a fibrous structure or a lamellar structure.

7. The voltage nonlinear resistive element according to claim 5, wherein in the voltage nonlinear resistive material, the copper matrix phase and the composite phase constitute a fibrous structure or a lamellar structure, and the Cu phase and the Cu—Zr compound phase in the composite phase constitute a fibrous structure or a lamellar structure parallel to the fibrous structure or the lamellar structure formed of the copper matrix phase and the composite phase.

8. The voltage nonlinear resistive element according to claim 6, wherein the electrodes are arranged in parallel with the fibrous structure or the lamellar structure formed of the Cu phase and the Cu—Zr compound phase.

9. The voltage nonlinear resistive element according to claim 5, wherein in the voltage nonlinear resistive material, the composite phase having a short fiber shape is dispersed in the copper matrix phase.

10. The voltage nonlinear resistive element according to claim 1, wherein the voltage nonlinear resistive material is produced by a production method including:
a melting step of melting Cu and Zr to produce a molten metal;
a casting step of casting the molten metal to produce an ingot; and
a processing step of subjecting the ingot to wire drawing or rolling to produce a drawn wire rod or a rolled article.

11. The voltage nonlinear resistive element according to claim 10, wherein the electrodes are arranged in parallel with a drawing direction or a rolling direction of the voltage nonlinear resistive material.

12. The voltage nonlinear resistive element according to claim 1, wherein the voltage nonlinear resistive material has a Zr content of 0.2 at % or more and 18.0 at % or less and contains the balance being Cu.
